(19) United States
(12) Patent Application Publication
(10) Pub. No.: US 2013/0045054 A1
(43) Pub. Date: Feb. 21, 2013

(54) MACHINE FOR LAYING A FILM ON A LANDFILL SURFACE

(71) Applicant: Randall J. Kozak, Surrey (CA)

(72) Inventor: Randall J. Kozak, Surrey (CA)

(73) Assignee: EPI ENVIRONMENTAL TECHNOLOGIES (NEVADA) INC., Vancouver (CA)

(21) Appl. No.: 13/212,869

(22) Filed: Aug. 18, 2011

(51) Int. Cl. B09B 5/00

(52) U.S. Cl. 405/129.45; 405/129.95

(57) ABSTRACT

A machine (20) for laying a film on a landfill surface and depositing an anchoring material such as soil on the film is carried on the blade (22) of a bulldozer (24). The machine (20) has a pair of hoppers (28, 30) with an engine compartment (38) between them. The front walls (40) of the hoppers have exit slots (52) for the release of anchoring material onto the film as it is being laid. The hoppers have chain floors (62) for moving the anchoring material to the exit slots (52). A film roll holder 32 below the hoppers holds a roll (82) of film for unwinding onto the landfill surface as the machine is propelled.

### FIELD OF THE INVENTION

The invention pertains to the laying of sheets of material on a landfill surface to form a barrier between the landfill surface and the environment.

### BACKGROUND OF THE INVENTION

The covering of landfills is a practice required by regulation in many jurisdictions. For example, it is often required that the daily fill of garbage be covered at the end of the day, or that the landfill be covered when it is not in operation. It is known in the landfill industry to lay strips of film, such as polyethylene, in a side-by-side or overlapping arrangement to cover the landfill, and to place an anchoring material (sometimes called ballast) such as soil on the film to hold it in place. The daily waste disposal area that requires regular covering in a landfill may be large, and machines have been developed to apply strips of film to cover such areas. For example, Lammers et al., U.S. Pat. No. 5,536,116 and U.S. Pat. No. 5,620,281, disclose an apparatus which is carried by a landfill compactor for laying and anchoring a film. Other examples in the patent literature include Brauer et al., U.S. Pat. No. 6,267,535 and Kozak, U.S. Pat. No. 6,558,080.

The present invention provides improved apparatus for covering landfills.

### SUMMARY OF THE INVENTION

One aspect of the invention provides a machine for laying film on a landfill surface while simultaneously depositing an anchoring material on the film. The machine has a hopper having a front wall, a rear wall, two side walls between the front and rear walls, and a floor panel, the front wall having an exit slot for the release of anchoring material from the hopper; a chain floor for moving the anchoring material in the hopper in the direction of the exit slot; means for driving the chain floor; and a film holder below the hopper for holding a roll of film for unwinding onto the landfill surface as the machine is propelled, whereby anchoring material released from the exit slot in the hopper is deposited onto the film as it is being laid.

Another aspect of the invention provides a method for laying a film on a landfill surface and depositing an anchoring material on it. A machine is provided having a hopper holding the anchoring material, the hopper having a chain floor and a wall with an exit slot therein for the release of anchoring material. The machine is moved over the landfill surface. A strip of film unwinds from the machine onto the landfill surface as the machine is moved. The anchoring material is moved to the exit slot in the hopper wall by means of the chain floor and is released through the exit slot and deposited onto the strip of film.

Further aspects of the invention and features of specific embodiments of the invention are described below.

### BRIEF DESCRIPTION OF THE DRAWINGS

FIG. 1 is a side elevation view of an embodiment of the film-deploying machine mounted on the blade of a bulldozer.

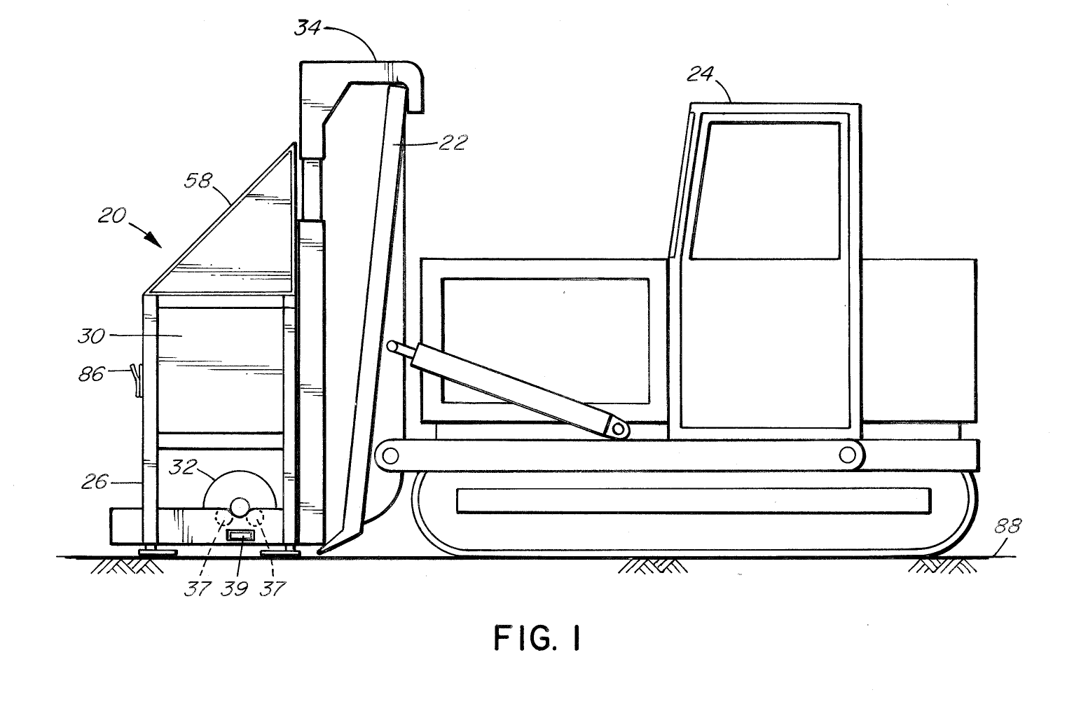

FIG. 2 is a front perspective view of the machine.

FIG. 3, is a side view of the machine, partly in section, with the top screen and hook assembly removed.

FIG. 4, is a front elevational view of the machine, partly cut away, with the top screen and the film roll removed for clarity.

FIG. 5 is a top plan view of the machine, partly in section, with the top screen removed.

### DETAILED DESCRIPTION OF THE PREFERRED EMBODIMENTS

The film-deploying machine 20 is adapted to be carried on the blade 22 of a bulldozer 24, or a compactor or similar vehicle. The machine has a frame 26 which supports a pair of hoppers 28, 30 for holding anchoring material, and a film roll holder 32. The frame is made of tubular steel members and includes generally vertical and horizontal frame members at the sides, front and rear of the machine, and diagonal members at the front of the hoppers. Two hook assemblies 34, comprising a vertical mast portion and a hook portion, are affixed to the frame at the rear of the machine, for hooking onto the bulldozer blade 22. The machine also includes legs 36, which are adjustable in length, permitting the machine to be supported on the landfill surface 88 at a selected height for convenient engagement with the bulldozer blade 22. The mast lengths and positions, and the hook lengths, are adjustable to fit blades of different sizes and shapes.

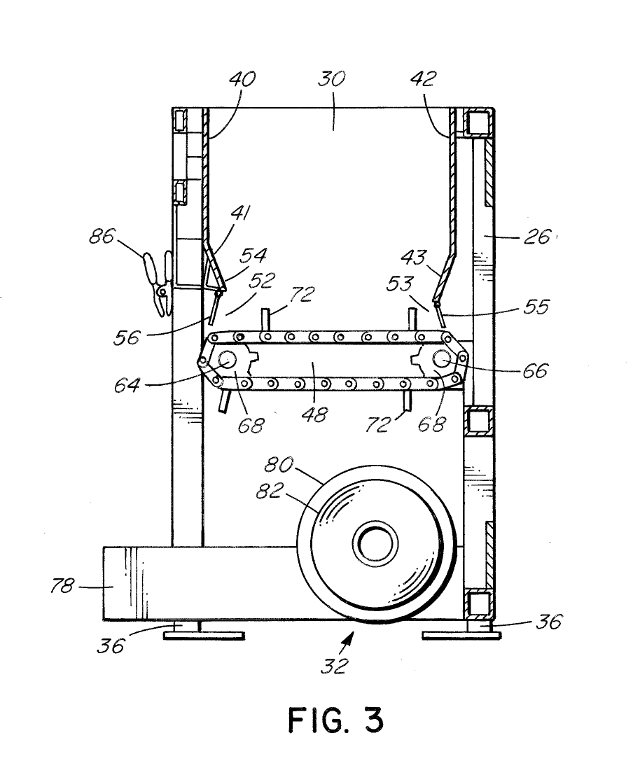

Each hopper has a front wall 40, a rear wall 42, an inner side wall 44, an outer side wall 46, and a floor panel 48. The hoppers are separated by an engine compartment 38, which is between the respective inner side walls 44. The side walls 44, 46 are substantially parallel to each other. The front and rear walls 40, 42 are also substantially parallel to each other, over most of their height, with a small inwardly-extending portion 41, 43 adjacent to their lower edges, as seen in FIG. 3.

There is an exit slot 52 between the lower edge 54 of each front wall 40 and the respective floor panel 48, extending laterally between the two side walls 44, 46 respectively of each hopper. The exit slots 52 are covered by a flexible rubber flap 56, attached along the lower edge 54 of the front walls 40. The lower edge of the flap is unattached. The hoppers have a screen 58 covering their open top, in the form of an inverted V having a sloping front part and a vertical back part. In use, anchoring material is loaded into the hoppers by dumping it from a loader onto the sloping front of the screen. The screen prevents pieces of anchoring material over a selected maximum size from being put into the hoppers. A cover 60 over the engine compartment 38 keeps anchoring material from entering it. The engine compartment also has a front door panel and a rear door panel (not shown in the drawings), which allow operator access to the compartment for re-fueling and servicing.

Each hopper 28, 30 has a conveyor 62 for moving anchoring material to the exit slots 52. The conveyor is of the chain floor type. In particular, there is a front drive shaft 64 and a rear shaft 66, both extending the full width of the machine, adjacent to the front and rear respectively of the hoppers 28, 30 and engine compartment 38. In the illustrated embodiment, there are three sprockets 68 on the front shaft and three on the rear shaft, in each of the two hoppers. Chains 70 engage respective pairs of front and rear sprockets 68 and extend around the shafts 64, 66 and the floor panel 48, forming continuous loops running above and below the floor panels. The adjacent chains 70 within each hopper are attached to spaced-apart push bars 72 which extend laterally between the chains. The bars comprise plates which extend above the profile of the chains and are adapted to engage anchoring material at the bottom of the hoppers and push it across the top surface of the floor panels 48. In the illustrated embodiment there are four equally-spaced push bars 72 carried by each set of chains, though more or fewer may be provided if desired. The rear walls 42 of the hoppers have an elongated opening 53 along their lower edge to provide clearance above the floor panels 48 for passage into the hoppers of the chains 70 and push bars 72. A flexible rubber flap 55 covers the opening 53 to minimize the loss of ballast through the opening. The flap flexes inwardly to permit movement of the push bars 72 into the hoppers.

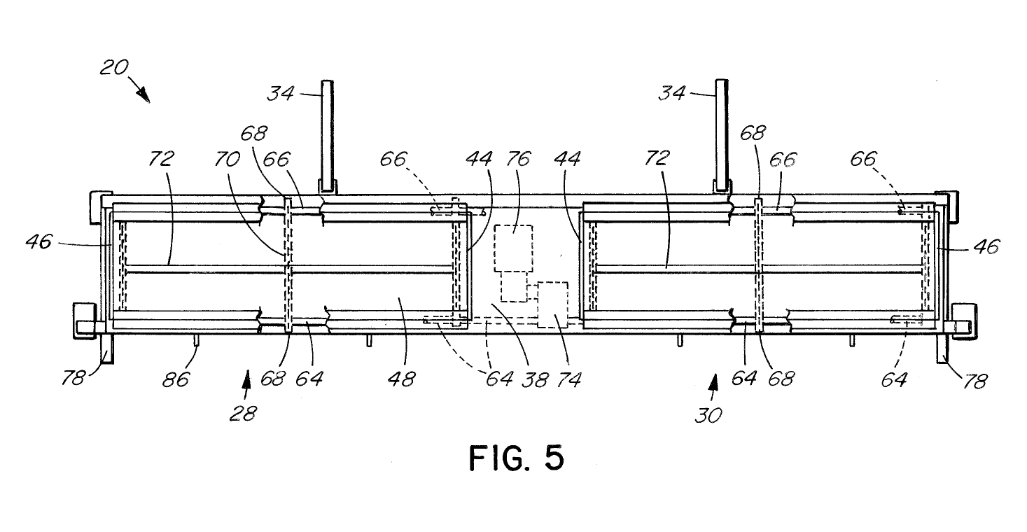

The engine compartment 38 houses the means the driving the conveyor. The front drive shaft 64 of the chain floor is operatively connected to a gear box 74. Drive means 76, shown schematically in FIG. 5, comprises a hydraulic motor powered by a diesel engine, with associated fuel tank and hydraulic fluid tank. The motor and gear box apply torque to the shaft 64, which in turn drives the chains 70 such that the push bars 72 are moved in the forward direction across the upper surface of the floor panels 48, pushing anchoring material towards the exit slots 52. The flap 56 can flex outward under the pressure of the push bars and the pushed material, permitting the release of material from the hoppers.

The machine 20 also includes conventional controls for operating the engine, the hydraulic motor and the chain floor. Such controls may also be provided, by suitable extension wiring, inside the bulldozer cab.

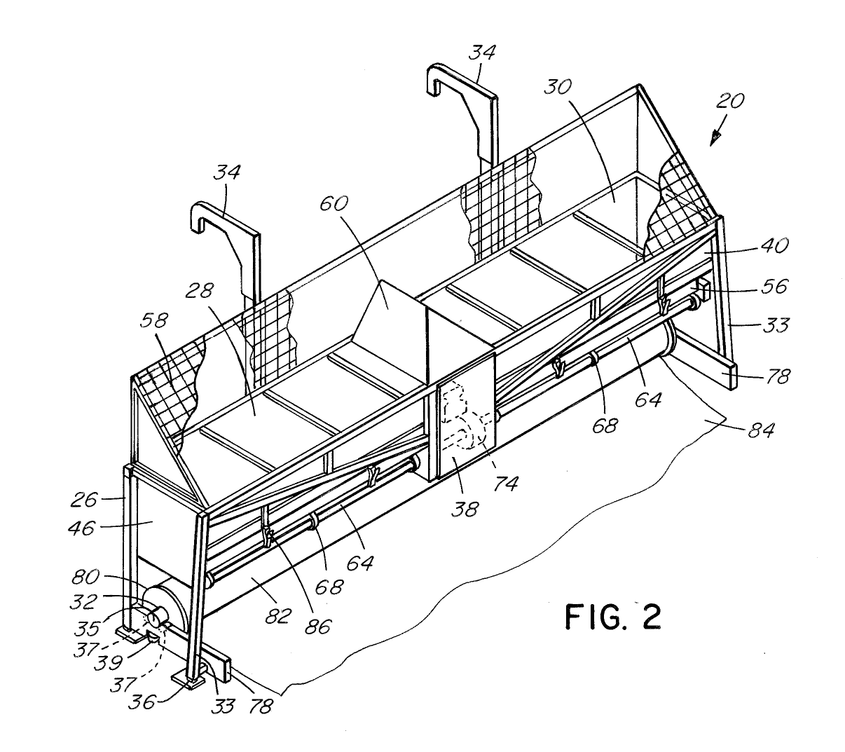

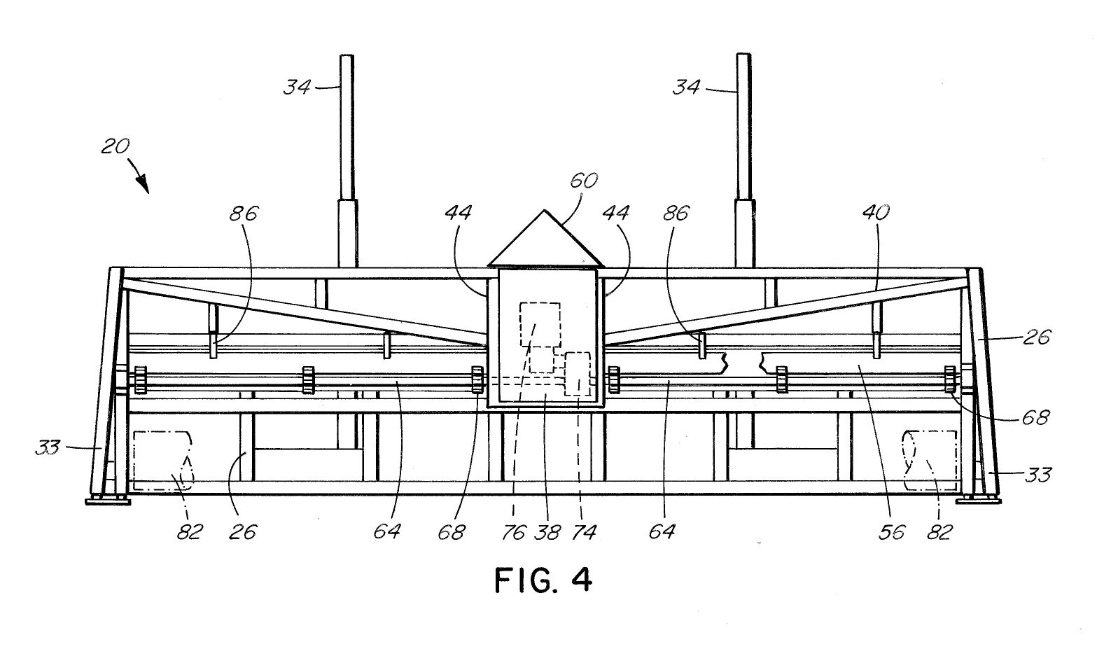

The frame 26 includes horizontal members 78 below the hoppers to support the film roll holder 32. The holder 32 is a spool with removable end caps 80 and serves to receive and hold a roll 82 of film 84, which may be unrolled off the spool as the machine is moved. The removable end caps have a plate which holds the film roll on the spool and a cylindrical protrusion 35 supported for rotation on wheels 37 in the horizontal members 78. As best seen in FIGS. 2 and 4, the front side members 33 of the frame slope outward slightly towards their lower end, providing a space between the horizontal members 78 and the lower part of the frame members 33. This space is sufficient to allow passage past the frame members 33 of the cylindrical protrusions 35 of the end caps 80, when the film roll holder 32 is rolled along the horizontal members 78 to either load the holder and film roll into the dispensing position on the machine or to remove the holder 32 when the film roll is empty. A bumper wheel 39, rotatable about a vertical axis, is provided in each member 78 to prevent the end caps 80 from contacting the members 78 during operation of the machine. Four clips 86 on the frame above the hopper openings 52 permit a free end of the film 84 to be held above the ground during transport of the machine.

The machine 20 is used to lay film on a landfill surface in accordance with the following method. The machine is picked up by the bulldozer blade 22, with the top of the blade supporting the hook assemblies 34, and the lower part of the frame 26 resting against the blade. The hoppers 28, 30 are loaded with anchoring material such as soil or earth, which is conventionally used as landfill cover. A roll of film is loaded onto the film roll holder. The film may be any sheet material suitable for the application, including textiles and laminates, though degradable polyolefin film is preferred. The film width may be, for example, 16 feet (4.9 meters). A length of film 84 is hung from the clips 86 to form a loop between the roll 82 and the clips. The chain floor is actuated and anchoring material is moved by the chain floor to the exit slots 52 and is dropped onto the hanging loop of film. This pulls the loop to the landfill surface 88 and tears or pulls the free end of the film from the clips 86. At this point the film is anchored to the landfill surface by the anchoring material. The bulldozer 24 is then driven in the rearward direction. A strip of film unwinds onto the landfill surface as the machine is moved and anchoring material is deposited from the hoppers onto the strip. The anchoring material is released from the hoppers across the full width of the exit slots 52 and accordingly falls across the film to hold it in place.

The volume of anchoring material delivered in a given time period is determined by the number and height of the push bars and the number of strokes per minute, i.e. the number of times a push bar passes the exit slot. An example of a suitable arrangement is four push bars 2 inches (5 cm) high operated at 12 strokes per minute. The chain floor may be operated to release anchoring material intermittently rather than continuously. For example, it may be run for 4 seconds, paused for 6 seconds, run for 4 seconds, and so on. For many applications, the film can be sufficiently anchored by intermittent rather than continuous release of ballast. By controlling the speed and duration of actuation of the chain floor, by means of the electronic controls of the machine, the release of ballast can be regulated in a manner suitable for the application. For example, a heavier release of ballast may be used if the film is laid in windy conditions, or if the film is intended for an extended cover period.

When the machine 20 has laid and anchored a strip of film to the end of the landfill working face or other selected position, the machine is stopped and the strip is cut, either manually or by automated cutting means. The free end of the strip of film on the roll is attached to the clips 86, so the film is in position to again receive anchoring material. The machine is then moved into position to lay a second strip parallel to the first strip and adjacent to or overlapping it. The operation is repeated, with periodic refilling of the hoppers as required, until the desired landfill surface area has been covered. The strips are applied in overlapping manner for applications that require a continuous, impermeable barrier at the landfill surface.

As will be apparent to those skilled in the art in the light of the foregoing disclosure, many alterations and modifications are possible in the practice of this invention without departing from the scope thereof. Accordingly, the scope of the invention is to be construed in accordance with the following claims.

1. A machine for laying a film on a landfill surface and depositing an anchoring material on the film, comprising:
(a) a hopper having a first wall, a second wall, two side walls between the first and second walls, and a floor panel, the first wall having an exit slot therein for the release of the anchoring material from the hopper;
(b) a chain floor for moving the anchoring material in the hopper in the direction of the exit slot;
(c) means for driving the chain floor; and
(d) a film roll holder for holding a roll of the film for unwinding onto the landfill surface as the machine is propelled, whereby anchoring material released from the exit slot of the hopper is deposited onto the film.

2. A machine according to claim 1, wherein the chain floor comprises a first shaft adjacent the first wall, a second shaft, chains which engage the shafts, and a plurality of movable push bars adapted to engage and push the anchoring material across the floor panel.

3. A machine according to claim 1, wherein the two side walls are substantially parallel to each other.

4. A machine according to claim 1, wherein the first and second walls are substantially parallel to each other over at least most of their height.

5. A machine according to claim 1, wherein the exit slot extends across the first wall along a lower edge thereof.

6. A machine according to claim 1, further comprising a flexible flap on the exit slot to control the release of anchoring material.

7. A machine according to claim 1, further comprising a second hopper with a chain floor.

8. A machine according to claim 1, further comprising a screen on top of the hopper for screening the anchoring material.

9. A machine according to claim 1, wherein the drive means comprises an engine and motor adjacent to the hopper.

10. A machine according to claim 7, wherein the drive means is located between the two hoppers.

11. A machine according to claim 1, wherein the drive means is operatively connected to drive the first shaft.

12. A machine according to claim 1, wherein the drive means includes means to drive the chain floor intermittently.

13. A machine for laying a film on a landfill surface and depositing an anchoring material on the laid film, comprising:
(a) a first hopper having a first wall, a second wall, two side walls between the first and second walls, and a floor panel, the first wall having an exit slot therein for the release of anchoring material from the first hopper;
(b) a second hopper having a first wall, a second wall, two side walls between the first and second walls, and a floor panel, the first wall having an exit slot therein for the release of anchoring material from the second hopper;
(c) a first chain floor for moving the anchoring material in the first hopper in the direction of the exit slot in the first hopper;
(d) a second chain floor for moving the anchoring material in the second hopper in the direction of the exit slot in the second hopper;
(e) an engine compartment between the first and second hoppers having means for driving the chain floors; and
(f) a film roll holder below the hoppers for holding a roll of the film for unwinding onto the landfill surface as the machine is propelled, whereby anchoring material released from the exit slots in the hoppers is deposited onto the film.

14. A method of laying a film onto a landfill surface and depositing an anchoring material on the film, comprising the steps of:
(a) providing a machine having a hopper holding the anchoring material, the hopper having a chain floor and a wall with an exit slot therein for the release of anchoring material;
(b) moving the machine over the landfill surface;
(c) unwinding a strip of the film onto the landfill surface as the machine is moved;
(d) moving the anchoring material to the exit slot in the hopper wall by means of the chain floor; and
(e) releasing the anchoring material through the exit slot and depositing it onto the strip of film.

15. A method according to claim 14, further comprising the step of controlling the release of the anchoring material through the exit slot by means of a flexible flap on the opening.

16. A method according to claim 14, wherein the anchoring material is moved and released intermittently.
